(19) United States
(12) Patent Application Publication
(10) Pub. No.: US 2024/0202662 A1
(43) Pub. Date: Jun. 20, 2024

(54) Automated Personalized Electronic Communication Assistant

(71) Applicant: International Business Machines Corporation, Armonk, NY (US)

(72) Inventors: Christine Mary Bunke, Fishkill, NY (US); Terry Staarmann, Boulder, CO (US); Lee N. Helgeson, Rochester, MN (US); Hongmei Li, Pleasant Valley, NY (US)

(21) Appl. No.: 18/084,916

(22) Filed: Dec. 20, 2022

(51) Int. Cl. G06Q 10/10; H04L 51/42

(52) U.S. Cl. CPC G06Q 10/10; H04L 51/42

(57) ABSTRACT

Mechanisms are provided which generate an action recommendation for a received electronic communication. A machine learning (ML) computer model is trained at least by executing a ML training operation based on electronic communication features extracted from a plurality of historical electronic communications and actions taken by a user in response to each historical electronic communication. The ML computer model is trained to predict an action classification that specifies a predicted action that the user will take in response to receiving electronic communications. A new electronic communication is received and electronic communication features are extracted from the new electronic communication. The extracted features are processed by the trained ML computer model to generate a predicted action classification and an action recommendation output specifying a recommended action to take corresponding to the predicted action classification for the new electronic communication.

### BACKGROUND

The present application relates generally to an improved data processing apparatus and method and more specifically to an improved computing tool and improved computing tool operations/functionality for implementing an automated personalized electronic communication assistant.

Modern interactions between people and between people and other entities, such as organizations, businesses, governments, etc., rely heavily on electronic communications, such as electronic mail, instant messaging, chats, and the like. In particular electronic email, or email, has proliferated everyday life with most individuals using one or more computing devices to check their email clients many times a day. The same is true of instant messaging, where individuals often spend long portions of the day communicating with other people via various instant messaging platforms.

With the increased usage of electronic communications, it is not unusual for individuals to receive 10s or even 100s of electronic communications in a single day. Moreover, many of these electronic communications may come from sources that are not known to the recipient and may be unwanted by the recipient. It may be very difficult and time consuming to sift through these electronic communications to find the ones that a user wishes to view/read and act upon. Moreover, the user, even though not wanting to view/read and act upon the other electronic communications, must still deal with them by either storing them for later, deleting them, flagging them for automatic blocking, or the like. Thus, whether wanted or not, users increasingly deal with larger and larger volumes of electronic communications, making it a time consuming and in some cases difficult task that may result in important communications being overlooked.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment, a computer-implemented method, in a computing device, is provided which generates an action recommendation for a received electronic communication. The method comprises training at least one machine learning computer model, at least by executing a machine learning training operation on the at least one machine learning computer model based on electronic communication features extracted from a plurality of historical electronic communications and actions taken by a user in response to each historical electronic communication in the plurality of historical electronic communications, as specified in a training dataset. The at least one machine learning computer model is trained to predict an action classification that specifies a predicted action that the user will take in response to receiving electronic communications. The method further comprises receiving a new electronic communication via one or more data networks and extracting electronic communication features of the new electronic communication. The method also comprises processing, by the trained at least one machine learning computer model, the electronic communication features of the new electronic communication to generate a predicted action classification for the new electronic communication. In addition, the method comprises generating an action recommendation output specifying a recommended action to take corresponding to the predicted action classification for the new electronic communication.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an example block diagram of the primary operational elements of an automated action recommendation engine in accordance with one illustrative embodiment;

FIG. 2 is an example diagram of a prioritized user interface in accordance with one illustrative embodiment;

FIG. 3 is an example diagram of a portion of an email database in accordance with one illustrative embodiment;

FIG. 4 is a flowchart outlining an example operation for predicting an action to be performed for a received email in accordance with one illustrative embodiment; and

FIG. 5 is an example diagram of a distributed data processing system environment in which aspects of the illustrative embodiments may be implemented and at least some of the computer code involved in performing the inventive methods may be executed.

### DETAILED DESCRIPTION

As discussed above, the ever increasing volume of electronic communications that individuals have to deal with on a daily basis has made it difficult to identify electronic communications that recipients wish to view/act upon and those which they do not. Taking electronic mail, or email, as a non-limiting example, it is difficult and time consuming to sort through the huge volume of emails that one receives each day to identify appropriate actions to take, e.g., delete, file, quick response draft, deferred action, or active attention. This is especially true as legitimate solicitors, and nefarious attackers, are increasingly using email as a way to obtain individuals' attention, with their emails often being intermixed with emails from friends, family, and business associates.

For example, in one test case, 64 emails were received in a single day for a particular user. Of these emails, 3 (5%) were emails that the user wanted to perform active actions, e.g., composing a comprehensive responsive email, 4 (6%) were emails that the user wanted to perform a simple action, e.g., forwarding the email, generating a simple message of a few words (e.g., “thanks”, “yes”, “I'll get back to you”), creating/canceling a calendar entry, etc., and 4 (6%) the user wanted to defer action, i.e., look at the email at a later time. In addition, 7 (11%) the user wanted to put on a watch list (may not need to do anything, but want to re-evaluate at a later time), 18 (28%) the user wanted to read and then file, 22 (35%) the user wanted to just file, and 6 (9%) the user wanted to delete. Thus, 17% of the emails required some action, including 6% that could be automated, e.g., the simple actions could be automated, and another 6% that were not urgent (deferred actions). 44% of the emails could be completely automatically handled, i.e., the file and delete emails. 28% require no action other than just reading the email, i.e., read and file. And the majority of the remainder, i.e., the watch list, will not require any action. Thus, for most of the 64 emails, no action is required on the part of the user as they can either automatically be handled, or no action is required in general. The issue is how to identify these different classes of emails with regard to user actions/automated actions.

Some tools have been developed for allowing users to define rules for moving emails to specified folders, such as the trash folder, or even blocking emails so as to avoid unwanted emails, e.g., SPAM filters. These mechanisms involve rules that specify contents, such as subject line contents, or email body contents, such that the rules are applicable to all emails, resulting in the potential to filter out or block legitimate emails that have the specified content. Thus, for these to work effectively, the user is required to carefully define the rules with the specific content that the user wishes to use as an indicator of emails to avoid. However, in this effort, not wanting to filter out legitimate emails, users tend to be conservative in their specification of the content that is an indicator for illegitimate emails resulting in unwanted emails getting through the filter; otherwise, if the user specifies broader content triggers, then legitimate emails will be filtered out. Thus, existing email solutions do not allow for an automated intelligent classification and handling of emails where this automated mechanism can be personalized to the particular user.

It should be appreciated that while the description of the illustrative embodiments will reference electronic mail (email) as the electronic communications with which the automated improved computing tool mechanisms and functionality operate, the illustrative embodiments are not limited to such. Rather, the illustrative embodiments may operate with regard to any electronic communications which are to be classified according to a prediction of user actions to be performed with regard to the electronic communications. For example, the illustrative embodiments may operate on instant messages of one or more instant messaging computing systems and applications, without departing from the spirit and scope of the present invention.

The illustrative embodiments provide an improved computing tool and improved computing tool functionality/operation which processes natural language content of electronic communications, e.g., emails, using natural language processing and one or more machine learning trained computer models, e.g., neural networks, in order to predict an action for the recipient, or user, to take based on a historical analysis of previous actions taken by the particular user with regard to similar electronic communications, as represented in training data. Based on the predictions, priorities of electronic communications are determined for bringing to the attention of the recipient via an organized user interface that is organized according to the predicted actions and the priorities. In addition, automated operations may be applied to electronic communications for which predicted actions correspond to actions that can be performed automatically without intervention of the recipient. The illustrative embodiments leverage machine learning of a specific user's previous historical actions with regard to specific features extracted from the content of previously received emails. In this way, the machine learning computer models learn the specific actions preferred by the particular user for particular types of electronic communications. Thus, a personalized electronic communication responsive action recommendation engine is trained which can then be used to recommend actions for future received electronic communications, present those recommendations to a user for confirmation, and/or perform automated actions automatically without user intervention when appropriate.

That is, based on historical action data corresponding to historical electronic communications (e.g., emails), one or more machine learning computer models are trained to perform classifications and predictions based on such classifications. For example, the one or more machine learning computer models may be trained to identify important/urgent emails requiring immediate attention, emails to forward to another person, emails to create a calendar entry based on calendar availability, emails to respond to with a simple email response, emails for which drafting of a complete response and initiate a thread of emails is warranted, emails to automatically archive, emails to automatically delete, emails to read and then archive, emails to put in a watchlist, and emails to put in a deferred action list. These are examples of email classifications that the one or more machine learning computer models may classify emails into, however it should be appreciated that the illustrative embodiments are not limited to such and other classifications which may be associated with recommended actions may likewise be used in addition to or in replacement of one or more of the above classifications.

Based on the classification of the incoming email generated by the one or more machine learning computer models, the email may be prioritized relative to other emails present in an email listing within a given period of time. This prioritization may be with regard to all emails in a corresponding folder of an email client application, e.g., within an inbox. In some cases, this prioritization may be temporally limited, e.g., for emails that have been received since the user last logged onto their email client application, within the last day, within the last week, etc., the emails may be prioritized relative to one another. The classified emails may be stored in subfolders or provided with corresponding classifier designations in the email client application so that they can be grouped together by classification and then prioritized within the classification as well as prioritized between classifications, e.g., emails that are classified as a class for drafting a comprehensive responsive email to initiate an email thread may be given a highest relative priority which is higher than emails that are classified as “read and archive”. Within the “comprehensive responsive email” classification, multiple emails in this classification may be prioritized relative to one another. Thus, emails may be automatically prioritized based on the predicted recommended actions, i.e., the specific classifications, and based on specific features of the content of the emails that are classified in a same predicted recommended action classification.

For some predicted recommended action classifications automated operations may be automatically initiated, where the operations are specific to the particular recommended action. For example, if a recommended action classification is one for creating a calendar entry, then automated processes may be initiated to check calendar availability and suggest the best slot based on reading the email request, the current calendar entries, preferences of the recipient, and possibly the calendar of the sender to negotiate a calendar entry. As another example, if the recommended action classification is one for generating a simple email, the responsive email may be automatically generated using corresponding email templates by retrieving the templates from an email template database based on content of the received email.

If the recommended action classification is “read and archive”, the email may be automatically placed in a special folder to read the email. When the user reads the email, the email may then be automatically moved to an archive folder, or the user may be prompted to archive the email due to the email being in this special folder.

If the recommended action classification is to add the email to a “deferred action list” the email may be automatically added to the deferred action list and this deferred action list may be periodically displayed to the user for the user to consider reading/acting on the received email. If the recommended action classification is to add the email to a watchlist, the email may be added to the watchlist and periodically the watchlist may be displayed to the user for considering reading and/or act on the email. The watchlist differs from the deferred action list in that after the user reads/acts on the email, the email may be automatically moved to the archive or to the deferred action list if further action is needed. The user may be prompted as to whether the email should be moved to archive or the deferred action list.

In some illustrative embodiments, the user's responsive actions may be recorded for emails to then associate the actions with the email features and update an email database which is used to continuously learn the user's specific desired actions for particular types of emails. For example, the mechanisms of the illustrative embodiments may present a recommended action for the user to take and determine whether the user agrees with or disagrees with the recommended action. The user's response is associated with the email features and in the case that the user disagrees and takes an alternative action, the alternative action may be recorded and associated with the email features. This information is stored as an entry in the email database which is then used to update the training of the one or more machine learning computer models, e.g., if the user disagrees with the recommended action, and an alternative action is performed, then the operational parameters of the one or more computer models may be adjusted so as to decrease the likelihood that the recommended action is again recommended for these email features, while increasing the likelihood of the actual action taken being recommended.

Thus, the illustrative embodiments provide an improved automated computing tool and corresponding functionality for learning, through machine learning processes, the specific correlations of email features and actions taken by a user so that classifications/predictions of recommended actions may be automatically generated when a new email is received. The illustrative embodiments further provide mechanisms for prioritizing emails based on the classifications/predictions and presenting an ordered graphical user interface, such as via an email client application or the like, which clearly specifies the different classifications/predictions and priorities of emails. In some illustrative embodiments, the improved automated computing tool provide functionality for automatically initiating operations to perform responsive actions to received emails, where these responsive actions correlate with the learned actions that the particular user typically takes in response to emails with certain combinations of features. Thus, the illustrative embodiments assist users in identifying which types of actions to take with regard to received emails as well as the priority by which the user should address the emails. Moreover, the illustrative embodiments alleviate some of the burden of responding to emails by automatically initiating certain actions which do not require the user's specific intervention.

Before continuing the discussion of the various aspects of the illustrative embodiments and the improved computer operations performed by the illustrative embodiments, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on hardware to thereby configure the hardware to implement the specialized functionality of the present invention which the hardware would not otherwise be able to perform, software instructions stored on a medium such that the instructions are readily executable by hardware to thereby specifically configure the hardware to perform the recited functionality and specific computer operations described herein, a procedure or method for executing the functions, or a combination of any of the above.

The present description and claims may make use of the terms “a”, “at least one of”, and “one or more of” with regard to particular features and elements of the illustrative embodiments. It should be appreciated that these terms and phrases are intended to state that there is at least one of the particular feature, or element, present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

Moreover, it should be appreciated that the use of the term “engine,” if used herein with regard to describing embodiments and features of the invention, is not intended to be limiting of any particular technological implementation for accomplishing and/or performing the actions, steps, processes, etc., attributable to and/or performed by the engine, but is limited in that the “engine” is implemented in computer technology and its actions, steps, processes, etc. are not performed as mental processes or performed through manual effort, even if the engine may work in conjunction with manual input or may provide output intended for manual or mental consumption. The engine is implemented as one or more of software executing on hardware, dedicated hardware, and/or firmware, or any combination thereof, that is specifically configured to perform the specified functions. The hardware may include, but is not limited to, use of a processor in combination with appropriate software loaded or stored in a machine readable memory and executed by the processor to thereby specifically configure the processor for a specialized purpose that comprises one or more of the functions of one or more embodiments of the present invention. Further, any name associated with a particular engine is, unless otherwise specified, for purposes of convenience of reference and not intended to be limiting to a specific implementation. Additionally, any functionality attributed to an engine may be equally performed by multiple engines, incorporated into and/or combined with the functionality of another engine of the same or different type, or distributed across one or more engines of various configurations.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

It should be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

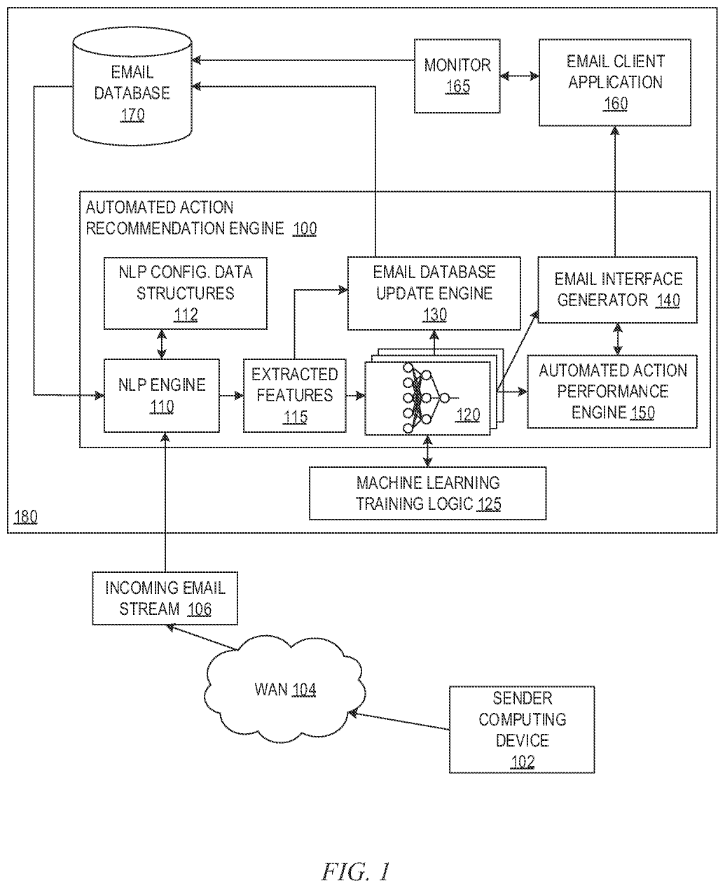

FIG. 1 is an example block diagram of the primary operational elements of an automated action recommendation engine in accordance with one illustrative embodiment. As shown in FIG. 1, the automated action recommendation engine 100 includes a natural language processing (NLP) engine 110 with corresponding NLP configuration data structures 112, one or more machine learning computer models 120 that are trained via machine learning training logic 125, an email database update engine 130, an email interface generator 140, and an automated action performance engine 150. During training of the one or more machine learning computer models 120, the automated action recommendation engine 100 operates on email data from the email database 170, which may store historical email data including email features extracted from the email and actions taken by the user in response to the particular emails. During runtime operation, i.e., after an initial training of the one or more computer models 120, the automated action recommendation engine 100 operates on an incoming email stream 106 received by the computing device 180 from one or more sender computing devices 102 via the wide area network (WAN) 104, e.g., the Internet. The automated action recommendation engine 100 may operate with an email client application 160 to present email classification/prediction information, prioritization information, and receive user responses to action recommendations as well as user inputs for reading and/or performing responsive actions to received emails.

During a training operation for training the one or more machine learning computer models 120 of the automated action recommendation engine 100, a plurality of historical emails from the email database 170 are processed through the automated action recommendation engine 100 to thereby generate classifications/predictions of the next action for a user to take in response to an email. The historical emails may be collected for a period of time from the email client application 160 by an email client monitoring engine 165, for example. That is, email content and corresponding actions taken by a user may be collected by the email client monitoring engine 165 and used to create entries in the email database 170. It should be appreciated that not all fields of the entry may be populated at this time and these entries may be updated based on the processing performed via the automated action recommendation engine 100 as described hereafter. The collected emails and actions may be used as a training data set and testing data set for training and testing the one or more machine learning computer models to generate action recommendations corresponding to the user's historical performance of actions. That is, based on the training data set, the one or more machine learning computer models learn a correlation between patterns of email features and corresponding ones of a plurality of email responsive action classifications/predictions.

The training dataset may be processed by the one or more machine learning computer models through multiple iterations or epochs in which an error or loss is determined during each iteration and adjustments to operational parameters, e.g., weights of nodes in a neural network computer model, are made to reduce the error or loss. This process is repeated until the error/loss is equal to or below a given threshold or until a predetermined number of iterations/epochs are performed. Once trained, in order to evaluate whether the one or more trained machine learning computer models 120 perform adequately, a testing dataset may be used to determine performance measures for the trained one or more machine learning computer models 120 and compare these performance measures to required or desired performance measures. This process is managed and executed by the machine learning training logic 125.

Assuming that a training dataset of historical emails and user actions has been acquired by the monitoring performed by the email client monitoring engine 165, the emails of the training dataset are processed via the natural language processing (NLP) engine 110 to extract features from the email content. The NLP engine 110 is specifically configured to extract specific features from the email content, as defined by the NLP configuration data structures 112. These NLP configuration data structures 112 may comprise dictionary data structures, synonym data structures, rules for feature extraction that are specific to email structures, and the like, which are specific to email content and desired features for extraction. For example, in one illustrative embodiment, the features extracted from the email content comprises the sender of the email, receiver of the email, other receiver(s), title or key terms found in the title, body content or key terms found in the body content, email thread designation, time stamp, a storage location, e.g., folder, in which the email is stored, and the like. For electronic communications that are requests to create a calendar entry, the creation time of the calendar entry and the created by features may be extracted. In some illustrative embodiments, patterns of natural language content, e.g., terms, phrases, and the like, may be specified in the NLP configuration data structures 112, and pattern matching may be performed, along with structural analysis based on specified structures of emails, e.g., the format of emails specifying sender fields, receiver fields, subject fields, body fields, and the like, to identify the features to extract.

The extracted features 115 are input to the one or more machine learning computer models 120 for processing. The one or more machine learning computer models 120 process the extracted features 115 of an email (this is done repetitively for a plurality of emails in the training dataset), such as through a plurality of layers of neural network computer model, to generate an output specifying a predicted action classification for the next action that the user is likely going to want to perform in response to the email being received. This predicted action classification may be a classification from a predetermined set of possible next actions that the user can perform including, for example, forwarding the email, creating a calendar entry, responding with a simple email response, drafting a more comprehensive responsive email and initiating an email thread, deleting the email, archiving the email, reading and then archiving the email, putting the email on a watchlist, putting the email in a deferred actions list, or the like.

The predicted action classification is compared to the actual action taken by the user in response to the email being received as indicated in the training dataset. The actual action taken by the user is considered to be a ground truth for the training operation. That is, the output of a machine learning computer model may be a binary output or a vector representation in which vector slots may be assigned to possible predicted action classifications and numeric values may be assigned to the vector slots based on the evaluations of the nodes in the machine learning computer model, e.g., neural network, recurrent neural network, deep learning neural network, random forest, support vector machine, decision tree computer model, or the like. In the case of a binary output, the computer model may output a first Boolean value, e.g., “1”, if a particular action classification applies to the email, and a second Boolean value, e.g., “0”, if it does not. In such an implementation, there would be a separate machine learning computer model for each possible action classification. In the case of a vector output, one or more machine learning computer models may be provided, where each machine learning computer model outputs a vector output with values in vector slots based on a predicted probability or confidence that the computer model has that the corresponding action classification applies to the input email features. These values may be any numeric value in the range from 0.0 to 1.0, for example, where 1.0 is complete confidence or likelihood, and 0.0 is complete lack of confidence or unlikelihood.

Thus, when comparing the actual action taken by the user and the predicted action classification, the numeric values in the vector slots, or Boolean values, are compared to determine a difference between the values. The difference is used with a predetermined loss function to determine an amount of error in the prediction relative to the ground truth, e.g., the actual action taken by the user. The computed loss or error is then used by machine learning training logic 125 to adjust the operational parameters of the one or more machine learning computer models 120 so as to minimize this loss/error in subsequent iterations. For example, the nodes in the machine learning computer model that had the most influence on the output may have their corresponding weights adjusted so as to reduce their influence and increase the influence of other nodes. This process may be repeated through multiple iterations or epochs with the same and different email inputs, e.g., each email in the training dataset, until the loss/error is equal to or below a threshold loss/error or a predetermined number of iterations/epochs has occurred, at which point the training of the machine learning computer model(s) is considered converged. This process is performed with regard to each machine learning computer model in the one or more machine learning computer models 120.

It should be appreciated that this machine learning training is training the machine learning computer models 120 to the specific actions that the particular user takes with regard to different types of emails. In this way, the trained machine learning computer models 120 are personalized to the particular user's previous taken actions for different types of emails, i.e., different patterns of input features. Thus, the machine learning computer models learn how this particular user acts in response to receiving different types of emails and then is able to predict how the user would want to act with newly received emails based on the features extracted from these newly received emails. Based on these predictions, automated actions may be taken to act on behalf of the user in an automated manner, organization of emails in an email interface of an email client application 160 may be performed based on the predictions such that emails of particular action classifications are more prominently presented in the organization, user prompts are presented to the user, or the like.

In some illustrative embodiments, the one or more machine learning computer models may also include a machine learning computer model for predicting a priority of an input email. This priority machine learning computer model may evaluate input features of emails that include, but are not limited to, email tags set by a sender of the email or the user indicating an importance level of the email, e.g., urgent, important, etc., whether the user responded to the email, a time between receiving the email and sending a response, a time between viewing the email and sending a response, whether the email was deleted or moved to a trash or junk folder, and the like. These features are all indicative of how important the email is relative to other emails, such that a prioritization of emails may be generated based on a scoring of these features. This prioritization may be performed within action classifications and/or across action classifications. The prioritization may also be based on the particular action class, where certain action classes have higher priority than others, e.g., emails that have an action class of deletion of the email have relatively lower priority than emails that have an action class of respond with a simple email response.

Thus, the email database 170 provides historical email data for emails previously received by the user and the corresponding actions taken by the user. This email data is input to the NLP engine 110 which executes NLP operations on the content of the email data to extract features 115 which are input to the machine learning computer model(s) 120 to train the machine learning computer model(s) 120 using the machine learning training logic 125. After training of the machine learning computer model(s) 120, new incoming emails 106 are received via one or more data networks, e.g., WAN 104, from one or more sender computing devices 102. The new incoming emails 106 are received by the computing device 180 and processed in a similar manner as the emails in the email database 170 via the NLP engine 110 to extract features 115 of the new emails. These features 115 of the new emails are input to the already trained machine learning computer model(s) 120 which operate on these features 115 to generate predicted action classifications for the new emails. Based on the predicted action classifications, a corresponding email interface is generated by the email interface generator 140 and/or automated actions are performed by the automated action performance engine 150.

In addition, the email database 170 may be updated based on the newly received email and results of processing the email via the NLP engine 110 and machine learning computer model(s) 120. Periodically, the updated email database 170 may be used to update the training of the machine learning computer model(s) 120 to thereby dynamically update the training based on user feedback to the predicted action classifications of newly received emails. That is, as discussed hereafter, generated email interfaces may include a recommended responsive action to perform based on the predicted action classification generated by the trained machine learning computer model(s) 120. In addition, user interface elements may be presented for the user to respond by agreeing with or disagreeing with the recommended responsive action. This user feedback may be fed back into the email database 170 by the monitor 165 along with other information about the newly received email, e.g., extracted features, predicted action classification, and other related information, to generate an entry for the newly received email, such as via the email database update engine 130. In addition, the monitor 165 may monitor the actual action taken by the user in response to the email, and update the corresponding entry in the email database 170 to specify what action was actually taken by the user. In this way, an expanded or updated training dataset is provided in the email database 170 which can later be used to perform a subsequent machine learning training operation on the machine learning computer model(s) 120 via the machine learning training logic 125.

In some illustrative embodiments, after training the machine learning computer model(s) 120, during runtime operation when new emails are received via the incoming email stream 106, the predicted action classifications generated by the trained machine learning computer model(s) 120 are used by the email interface generator 140 to generate a prioritized listing of emails and recommended actions to take with regard to each email. In some illustrative embodiments, the prioritized listing may be organized according to recommended action type and also according to predicted relative priority with regard to at least one of priority within a predicted action classification and/or across predicted action classifications. For example, if there are 10 emails, emails 1-3 having a first action classification, emails 6-7 and 10 having a second action classification, emails 4, 8, and 9 having a third action classification, and email 5 having a fourth action classification, with the first action classification having a highest priority, the second action classification having a second highest priority, the third action classification having a third highest priority, and the fourth action classification having a fourth highest priority, then these emails may have a priority listing of 1, 2, 3, 6, 7, 10, 4, 8, 9, 5. In some illustrative embodiments, if prioritization is performed within an action classification, the priority listing may be modified to, for example, 2, 3, 1, 7, 6, 10, 9, 4, 8, and 5 based on the relative priorities within action classifications based on specific features of the individual emails and the learned prioritization of the computer model(s) 120. In other illustrative embodiments, the prioritization may be performed by a prioritization algorithm that prioritizes emails based on a relative priority sequence of user actions, where the relative priority may be specific to the particular user. For example, one user's prioritization sequence may be: actively responding to the email, creating a calendar entry, sending a simple response, forwarding the email, initiating an email threat or chain, putting the email in a deferred action list, putting the email in a watchlist, reading the email and archiving the email, deleting the email, etc. This sequence may be specified by the user or automatically determined, such as based on the statistics of the lapse of time for performing a particular classification of action following receipt of the email. These are only examples and various other types of prioritization algorithms may be used without departing from the spirit and scope of the present invention.

The emails that are output in the priority listing may include a specification of the recommended action for the user to take, based on the specific predicted action classification. Again, these predictions of action classifications are based on the machine learning training which learns the specific responsive actions that the user takes with regard to the particular email types. Thus, one user may take different actions and prioritization than another user for the same email type. The predictions predict what this particular user is likely going to want to do in response to the particular email as learned through the machine learning process. Thus, for example, the priority listing may specify that for each email in the priority listing whether the user is recommended to respond to the email by actively responding to the email, creating a calendar entry, sending a simple response, forwarding the email, initiating an email thread or chain, putting the email in a deferred action list, putting the email in a watchlist, reading the email and archiving the email, deleting the email, or the like.

In addition, the priority listing generated by the email interface generator 140 may include a user interface element that is user selectable to specify whether the user accepts (agrees with) or does not accept (disagrees with) the recommended action. This user interface element provides user feedback that is capture by the monitor 165 and fed into the corresponding entry of the email database 170 for the email. If the user agrees with the recommended action, and the recommended action is one that can be performed automatically, then the automated action performance engine 150 may be invoked to automatically perform the recommended action. In some implementations, some action classifications and corresponding recommended actions may be taken automatically by the automated action performance engine 150 without requiring user agreement via a user interface. These action classifications for which automated action performance is to be performed may be specified by the user via a user profile or configuration data structure that is associated with the automated action performance engine 150, for example. Thus, when the trained computer model(s) 120 predict an action classification corresponding to one of these automated action performance classifications, then the automated action performance engine 150 may automatically perform the corresponding action without inquiring with the user via the user interface for authorization or agreement by the user. The automated actions taken can be recorded in a historical log and can be displayed to the user in a form per user request. Thus, the user can provide feedback to the automated actions via the form and corresponding user interface to stop any specific type of actions in the future. In some illustrative embodiments, such a form and user interface may be automatically output to the user for confirmation or authorization by the user to perform the automatic actions prior to the automatic actions commencing, or to cancel the automatic performance of the action. In some illustrative embodiments, a timeout period may be provided where, if the user has not responded within a given time to cancel the automated action, the automated action may then be automatically performed.

It should be appreciated that in some illustrative embodiments, the priority listing generated via the email interface generator 140 may further allow the user to provide user feedback as to the priority of the emails in the priority listing. That is, the user may reorganize the order of the priority listing so as to provide user feedback as to the relative priority of emails, such as via a drag-and-drop operation, specifying a numerical priority value to assign to the emails, interacting with an “up arrow” or “down arrow” user interface element to move the emails up/down the priority listing, or the like. This user feedback may also be captured by the monitor 165 and used to update the priority of the email in a priority characteristic of an entry in the email database 170. This user feedback, as well as the user feedback regarding the user's agreement/disagreement with the recommended action, and captured actions actually taken by the user with regard to the email, may be captured and provided to the email database 170 to update an entry for the email which includes the extracted features, predicted action classification, and recommended action information provided by the email database update engine 130.

With regard to specific automated actions that may be taken, either automatically without user specific agreement, or after having presented the recommended action to the user and received the user's responsive agreement to perform the automated action, the automated action performance engine 150 may forward emails to other recipients, generate calendar entries by implementing a scheduling negotiation with the sender of the requested calendar entry, generate and transmit simple responses to senders of emails, initiate composing of a more comprehensive email and corresponding email chain/thread, archive the email, delete the email, add the email to a watchlist, add the email to a deferred actions list and periodically present the deferred action list to the user via the client email application 160 and user interface generator 140, or the like.

With regard to forwarding emails to other recipients, there may be separate predicted action classifications for forwarding emails to different recipients. That is, the user may routinely forward emails to a subset of recipients and each of these recipients or sub-groupings of recipients, may be a separate predicted action classification for forwarding emails, e.g., if the user routinely forwards emails to co-worker 1, co-worker 2, their spouse, and a friend, then each of these may be a separate predicted action classification, all of which fall under the forwarding of the email, but with each being a different forwarding email predicted action classification for the different recipients. The user may specify that for classifications of forward email to spouse, that this classification can have the corresponding action performed automatically without user agreement via a user interface, while other forwarding classifications should request user agreement via the user interface generated by the user interface generator 140. Thus, if the computer model 120 predicts that, for a new email, that the email should be forwarded to the user's spouse, the automated action performance engine 150 may, in response to seeing the classification output from the computer model 120, automatically forward the email to the user's spouse via the email client application 160. For forwarding classifications that require user agreement, the email interface generator 140 may request user agreement through the priority listing as discussed above, and in response to user agreement, cause the automated action performance engine 150 to forward the email accordingly.

With regard to predicted action classifications of generating a calendar entry, the automated action performance engine 150 may automatically, or in response to user agreement via the email interface generated by the generator 140, initiate creation of a calendar entry in the user's electronic calendar, which may be provided via the email client application 160, for example. If the received email proposes a particular date/time and event duration for the calendar entry, the user's electronic calendar may be searched to ensure that the particular date/time is available and that the expected duration of the event does not overlap other calendar entries. If there is a conflict in the user's electronic calendar, an automated response may be generated and sent to the sender of the calendar entry request to propose an alternative date/time based on the user's current electronic calendar status. In some cases, an automated negotiation between the user's electronic calendar and the sender's electronic calendar may be performed to identify a date/time that is acceptable for each electronic calendar and automatically create a draft calendar entry that can be reviewed by the parties and accepted/rejected. The negotiated calendar entry may then be presented to the user and sender for confirmation that it is acceptable to both parties.

With regard to predicted action classifications for generating and transmitting simple responses to senders of emails, again there may be a separate “simple response” action classification for different types of simple responses that the user uses to respond to particular types of emails. These simple responses may be composed as template email responses that may be used to generate simple responses to newly received emails. These template responses may be populated with information from the newly received email, e.g., sender address, subject line, etc. so that the templates are customized for response to the particular new email received. The content of the template responses will depend on the personalized “simple response” action classification, e.g., “Thanks”, “Congratulations”, “Great Job!”, “Received with thanks”, etc. The automated action performance engine 150 may automatically retrieve the corresponding template from a template database (not shown) and populate the template with the information from the newly received email. The composed “simple response” email may then be transmitted to the sender of the newly received email as a responsive email via the email client application 160.

In the case that the predicted action classification is to initiate composing of a more comprehensive email and corresponding email chain/thread, this action cannot be performed automatically in its entirety as it requires use input to provide the content of the more comprehensive email. However, some portions of this action may be automatically performed by the automated action performance engine 150 via the email interface generator 140 and email client application 160. For example, the automated action performance engine 150 may initiate an interface for composing a responsive email and automatically populate the recipient fields, subject line, electronic signature, etc. for the responsive email. Thus, the user need only draft the content of the body of the email and initiate transmission once the body is complete.

With regard to predicted action classifications for archiving the email and deleting the email, these actions can be automatically performed by the automated action performance engine 150 by moving the email to the appropriate folders in the email client application 160, e.g., the deleted folder, trash folder, archive folder, or the like. With regard to the predicted action classifications for adding the email to a watchlist or adding the email to a deferred actions list, the emails may again be added to corresponding data structures in the email client application 160 and/or email interface generator 140 corresponding to a watchlist or deferred actions list. With the watch list and deferred actions list the emails that are stored in these data structures may be tracked by the email interface generator 140 such that periodically these lists may be presented via appropriate user interfaces to the user so that the user can consider actions to perform on the emails in these list data structures. The periodicity by which such user interfaces are presented may be different for the different list data structures, e.g., the watchlist may have its user interface displayed to the user more frequently than the deferred action list data structure, for example.

Based on the predictions generated by the computer model(s) 120, the email database update engine 130 generates entries in the email database 170 which store the extracted features 115 of the email, the predicted action classification, and other related information. The monitor 165 monitors user interactions with the email client application 160 with regard to accepting/not accepting recommended actions, actual actions taken by the user for specific emails, and performance of automated actions by the automated action performance engine 150 via the email client application 160, and updates the corresponding entries in the email database 170. Thus, the training data in the email database 170 is dynamically expanded and updated to include runtime user actions to emails from which the machine learning computer model(s) 120 may learn the user's specific actions that they would like to take in response to particular types of emails, over time. The updated data in the email database 170 may be used continuously, or periodically, to update the training of the computer model(s) 120 via a similar machine learning training operation as previously described above.

As noted above, the email interface generator 140 may generate a user interface for presenting a prioritized list of received emails which is prioritized according to the predicted action classification and the specific content within each email. This prioritized listing may be presented by way of a reorganization of the listing of emails in the email client application 160, as a separate priority listing linked to the email listing in the email client application 160, or as a hybrid new user interface that combines the user interface elements of the email client application 160 with the prioritized listing user interface elements.

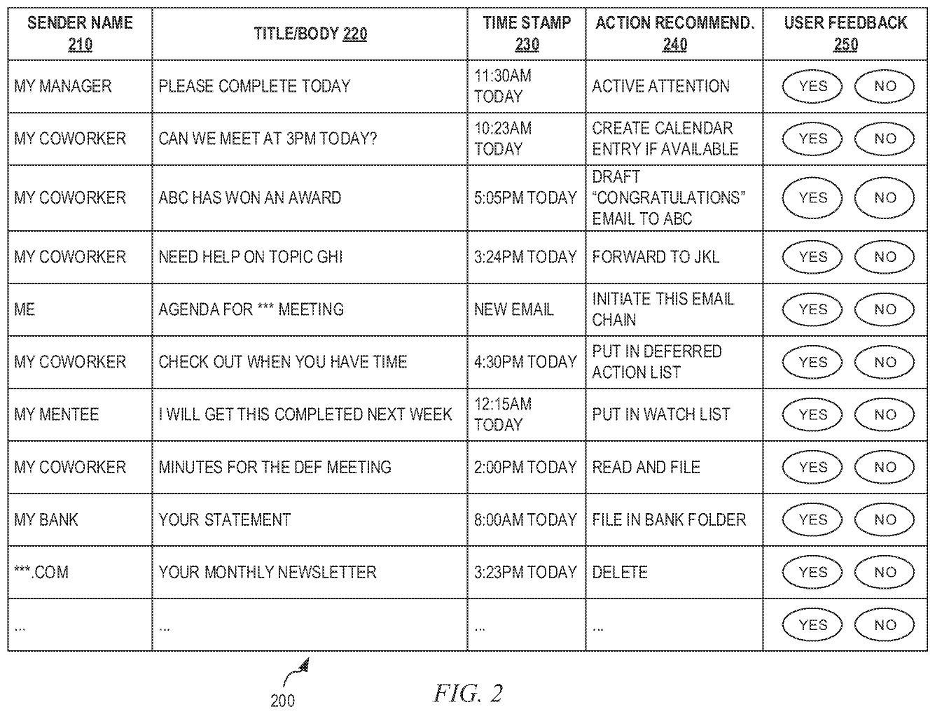

FIG. 2 is an example diagram of a prioritized user interface in accordance with one illustrative embodiment in which a separate prioritized listing of emails is generated by the email interface generator 140 and presented via the email client application 160 to a user for user interaction and performance of responsive actions. As shown in FIG. 2, the priority listing 200 includes entries having various email data including a name of a sender 210, a title/body 220, a time stamp 230, a recommended or suggested action 240, and user interface elements 250 for inputting the user's agreement or non-agreement with the recommended or suggested action. The contents of each of these fields of the entry will be specific to the particular email and at least for fields 210-230, these contents may be extracted by the NLP engine 110 as extracted features 115. It should be appreciated that these are only examples of fields that may be included in the entries of the priority listing and other fields may be used in addition to, or in replacement of, these fields without departing from the spirit and scope of the present invention.

In the depicted example, the email entries in the priority listing are prioritized with the highest priority emails being listed first with priority descending thereafter. As shown in FIG. 2, the emails have various recommended/suggested actions based on the computer model(s) 120 predictions of action classifications for the emails based on the features extracted from these emails. The user interface elements 250 allow the user to provide a user input selecting whether to agree with (Yes) or not agree with (No) the specific recommended/suggested action in field 240. This user feedback is captured by the monitor 165 and used to update entries in the email database 170 which are in turn used for dynamic updating of the training of the machine learning computer models 120. Moreover, in response to the user inputting an agreement with the recommended/suggested action, the automated action performance engine 150 may then automatically execute the corresponding recommended/suggested action, such as those previously described above.

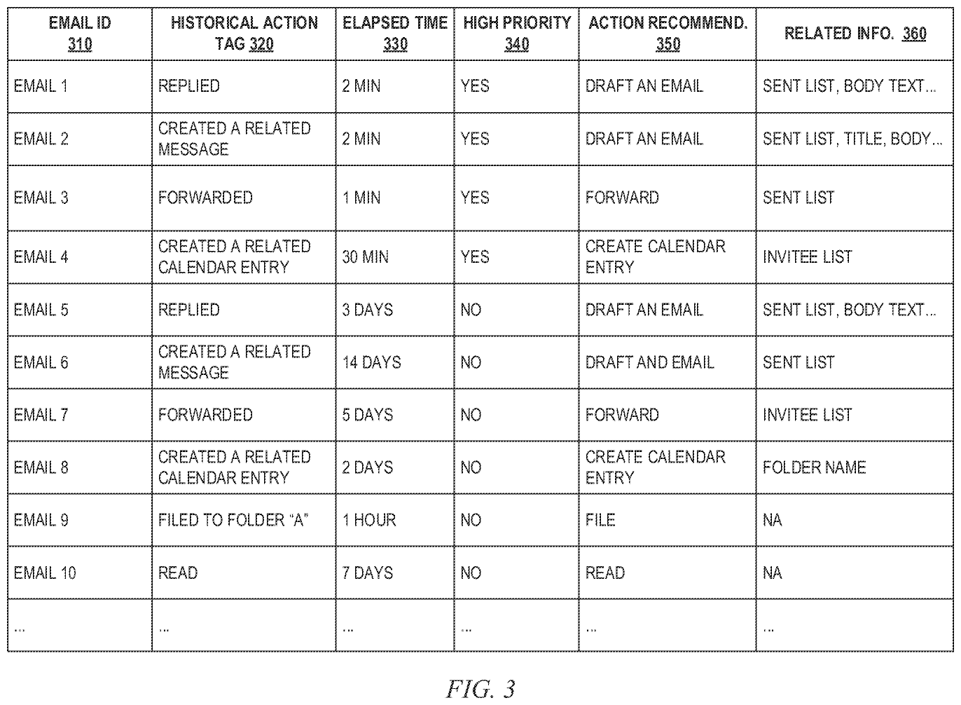

The training of the machine learning computer model(s) 120 is based on historical email data stored in the email database 170, which may be dynamically updated from an initial set of training data and testing data based on runtime incoming email stream 106 and the results of the operation of the automated action recommendation engine 100. FIG. 3 is an example diagram of a portion of an email database in accordance with one illustrative embodiment. As shown in FIG. 3, entries in the email database may include various email data including an email identifier 310, historical action tag 320, lapse of time from received email to user action 330, high priority tag 340, recommended/suggested action 350, and other related email data 360, such as extracted email features, user feedback about recommended actions, and the like.

The email identifier 310 is used to correlate the entry in the email database with specific emails in the email client application 160 and for updating the entries by way of the monitor 165 based on user input to the email client application 160 and/or email database update engine 130. The historical action tag 320 comprises a tag corresponding to the actual action taken for the email identified by the email identifier. That is, this actual action taken is an action taken by the user via the email client application 160 and/or the automated action performance engine 150. For example, if the user or automated action performance engine 150 replied to the email, created a related message, forwarded the email, created a calendar entry, filed the email in a folder, read the email, deleted the email, or took now action, for example, the corresponding tag identifying this action is stored in field 320 of the corresponding email entry.

The lapse of time field 330 specifies how long it took for the corresponding action to be performed after receipt of the email. This lapsed time indicates a relative priority or importance of the email, as shorter lapsed times indicates more immediate attention by the user to the email. The high priority tag 340 indicates whether a sender of the email indicated the email to have a high priority or not. These fields 330-340 may be used along with the recommended action field 350 to prioritize emails in the prioritized listing as previously described above.

The recommended action field 350 is similar to field 240 in FIG. 2, and specifies the recommended action corresponding to the predicted action classification output by the machine learning computer model(s) 120 for the email. It should be appreciated that the action recommended in field 350 may not match the action actually taken as specified in the field 320. Thus, for example, the computer model(s) 120 may classify the email in a “forward email” classification corresponding to the “forward” action, but this does not mean that the user actually forwarded the email and instead the user may have taken a different action as represented in field 320.

The field 360 comprises other email data that facilitates the operations previously described above with regard to one or more of the illustrative embodiments, and specifically with regard to training the machine learning computer model(s) 120. For example, this field 360 may in fact be multiple fields or may store multiple different types of email data, such as extracted features 115 generated by the NLP engine 110 by processing the email, priority score of the email, and/or the like. This information may be used along with the machine learning training logic 125 to train the machine learning computer model(s) 120 initially and then dynamically after an initial training is performed. That is, initially, the email database 110 may comprise a training dataset and testing dataset that are used to initially train and test the computer model(s) 120. However, the email database 110 may thereafter be updated to include additional entries based on the incoming email stream 106 and processing of this incoming email stream 106 via the automated action recommendation engine 100. These new entries in the email database 110 may be used separately, or in combination with the original training/testing datasets, to update the training of the machine learning computer model(s) 120.

Thus, the illustrative embodiments provide an improved computing tool and improved computing tool functionality/operations for automatically learning how a particular user responds to received emails, i.e., what actions they take, and trains one or more machine learning computer models to classify new emails with regard to predicted actions that the user will want to take in response to receiving the new email, based on this learning. The illustrative embodiments provide mechanisms for generating action recommendations that are output to the user in a prioritized listing for consideration in determining which emails need more immediate attention and action by the user and providing a suggested or recommended action for the user to take. In some cases, the user need only indicate their agreement with the suggested/recommended action for that action to be automatically performed on their behalf. In other cases, the user need not provide any specific agreement and actions may in fact be taken automatically without the user's intervention. While recommended actions require user agreement and/or can be performed automatically without explicit user agreement may be set forth in configuration or user profile data of an automated action performance engine. By implementing these mechanisms, automated computing tools are provided that make it easier for users to focus their attention on emails that are likely to require their immediate attention and their specific user input while other emails that can be handled automatically are handled accordingly without having to involve the user if possible. This allows prioritizing of emails and organization of emails such that the user need not comb through a large volume of emails to find the ones that need their immediate and personal attention.

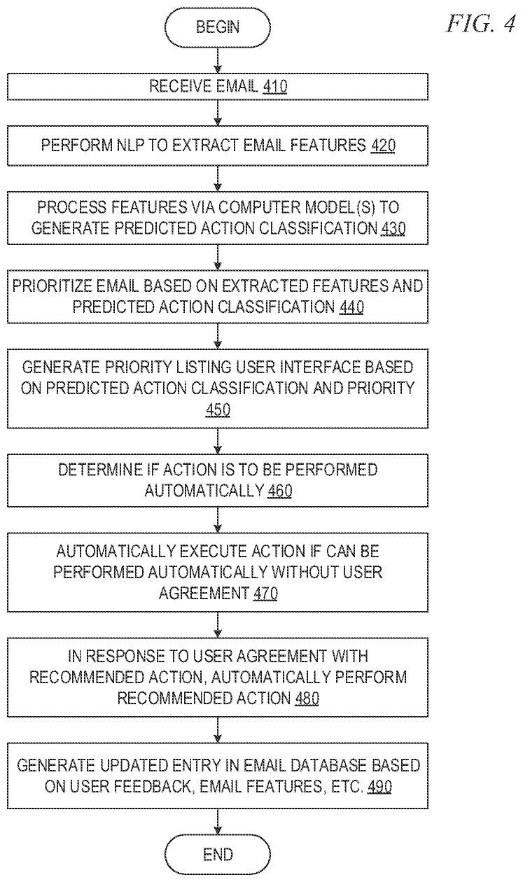

FIG. 4 is a flowchart outlining example operations of elements of the present invention with regard to one or more illustrative embodiments. It should be appreciated that the operations outlined in FIGS. 3-4 are specifically performed automatically by an improved computer tool of the illustrative embodiments and are not intended to be, and cannot practically be, performed by human beings either as mental processes or by organizing human activity. To the contrary, while human beings may, in some cases, initiate the performance of the operations set forth in FIGS. 3-4, and may, in some cases, make use of the results generated as a consequence of the operations set forth in FIGS. 3-4, the operations in FIGS. 3-4 themselves are specifically performed by the improved computing tool in an automated manner.

FIG. 4 is a flowchart outlining an example operation for predicting an action to be performed for a received email in accordance with one illustrative embodiment. The operation outlined in FIG. 4 assumes that the action classification prediction computer model(s), e.g., computer model(s) 120 in FIG. 1, have been trained through a machine learning training operation in accordance with one or more of the illustrative embodiments previously described. The operation outlined in FIG. 4 may be performed, for example, by the automated action recommendation engine 100 in FIG. 1. Again, while the present description uses email as an example of the electronic communications with which the illustrative embodiments are implemented, it should be appreciated that the mechanisms of the illustrative embodiments are also applicable to other types of electronic communications, such as instant messages, chat dialogs, and the like.

As shown in FIG. 4, the operation starts by receiving an email as part of an incoming email stream from one or more sender computing devices via one or more data networks (step 410). The received email is processed by natural language processing logic to extract email features (step 420). The email features are input to the trained machine learning computer model(s) to classify the email with regard to a predicted action classification specifying a prediction as to which action the user is likely to want to perform in response to receiving the email (step 430). The trained machine learning computer model(s) also prioritize the email by generating a prioritization score based on the extracted features and the predicted action classification of the email (step 440). The predicted action classification and prioritization score are used to generate a priority listing user interface that is output to the user via an email client application (step 450).

In addition, the predicted action classifications are compared to user profile or configuration data of an automated action performance engine to determine if the action corresponding to the predicted action classification should be performed automatically without requiring explicit user agreement (step 460). For those actions that can be performed without explicit user agreement, the action is automatically performed by the automated action performance engine (step 470). For those actions for which the user provides explicit user agreement via the prioritized listing user interface, those actions are also automatically performed, if possible (step 480). The user feedback, email features, captured actions performed, and other email data are used to update the email database for future updated training of the machine learning computer model(s) (step 490). The operation then terminates.

The present invention may be a specifically configured computing system, configured with hardware and/or software that is itself specifically configured to implement the particular mechanisms and functionality described herein, a method implemented by the specifically configured computing system, and/or a computer program product comprising software logic that is loaded into a computing system to specifically configure the computing system to implement the mechanisms and functionality described herein. Whether recited as a system, method, or computer program product, it should be appreciated that the illustrative embodiments described herein are specifically directed to an improved computing tool and the methodology implemented by this improved computing tool. In particular, the improved computing tool of the illustrative embodiments specifically provides improved computing tool functionality for automatically predicting actions to be taken by a specific user, in a personalized manner based on the specific user's past behavior with regard to electronic communication types, and then presenting a prioritized listing of electronic communications with recommended actions and, in some cases, automatically performing recommended actions without user intervention. The improved computing tool implements mechanism and functionality, such as that described above, which cannot be practically performed by human beings either outside of, or with the assistance of, a technical environment, such as a mental process or the like. The improved computing tool provides a practical application of the methodology at least in that the improved computing tool is able to prioritize and recommend actions to be performed in response to electronic communications that is personalized to a particular user and reflects the user's previous historical actions with regard to different types of electronic communications.

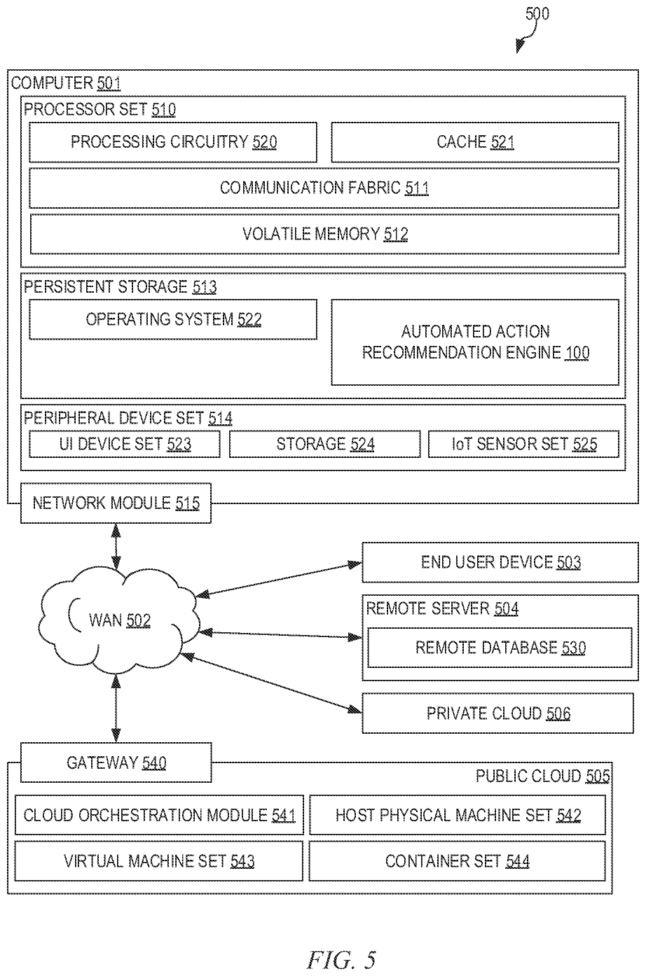

FIG. 5 is an example diagram of a distributed data processing system environment in which aspects of the illustrative embodiments may be implemented and at least some of the computer code involved in performing the inventive methods may be executed. That is, computing environment 500 contains an example of an environment for the execution of at least some of the computer code involved in performing the inventive methods, such as automated action recommendation engine 100. In addition to block 100, computing environment 500 includes, for example, computer 501, wide area network (WAN) 502, end user device (EUD) 503, remote server 504, public cloud 505, and private cloud 506. In this embodiment, computer 501 includes processor set 510 (including processing circuitry 520 and cache 521), communication fabric 511, volatile memory 512, persistent storage 513 (including operating system 522 and block 200, as identified above), peripheral device set 514 (including user interface (UI), device set 523, storage 524, and Internet of Things (IoT) sensor set 525), and network module 515. Remote server 504 includes remote database 530. Public cloud 505 includes gateway 540, cloud orchestration module 541, host physical machine set 542, virtual machine set 543, and container set 544.

Computer 501 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 530. As is well understood in the art of computer technology, and depending upon the technology, performance of a computer-implemented method may be distributed among multiple computers and/or between multiple locations. On the other hand, in this presentation of computing environment 500, detailed discussion is focused on a single computer, specifically computer 501, to keep the presentation as simple as possible. Computer 501 may be located in a cloud, even though it is not shown in a cloud in FIG. 5. On the other hand, computer 501 is not required to be in a cloud except to any extent as may be affirmatively indicated.

Processor set 510 includes one, or more, computer processors of any type now known or to be developed in the future. Processing circuitry 520 may be distributed over multiple packages, for example, multiple, coordinated integrated circuit chips. Processing circuitry 520 may implement multiple processor threads and/or multiple processor cores. Cache 521 is memory that is located in the processor chip package(s) and is typically used for data or code that should be available for rapid access by the threads or cores running on processor set 510. Cache memories are typically organized into multiple levels depending upon relative proximity to the processing circuitry. Alternatively, some, or all, of the cache for the processor set may be located “off chip.” In some computing environments, processor set 510 may be designed for working with qubits and performing quantum computing.

Computer readable program instructions are typically loaded onto computer 501 to cause a series of operational steps to be performed by processor set 510 of computer 501 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 521 and the other storage media discussed below. The program instructions, and associated data, are accessed by processor set 510 to control and direct performance of the inventive methods. In computing environment 500, at least some of the instructions for performing the inventive methods may be stored in block 200 in persistent storage 513.

Communication fabric 511 is the signal conduction paths that allow the various components of computer 501 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 512 is any type of volatile memory now known or to be developed in the future. Examples include dynamic type random access memory (RAM) or static type RAM. Typically, the volatile memory is characterized by random access, but this is not required unless affirmatively indicated. In computer 501, the volatile memory 512 is located in a single package and is internal to computer 501, but, alternatively or additionally, the volatile memory may be distributed over multiple packages and/or located externally with respect to computer 501.

Persistent storage 513 is any form of non-volatile storage for computers that is now known or to be developed in the future. The non-volatility of this storage means that the stored data is maintained regardless of whether power is being supplied to computer 501 and/or directly to persistent storage 513. Persistent storage 513 may be a read only memory (ROM), but typically at least a portion of the persistent storage allows writing of data, deletion of data and re-writing of data. Some familiar forms of persistent storage include magnetic disks and solid state storage devices. Operating system 522 may take several forms, such as various known proprietary operating systems or open source Portable Operating System Interface type operating systems that employ a kernel. The code included in block 200 typically includes at least some of the computer code involved in performing the inventive methods.

Peripheral device set 514 includes the set of peripheral devices of computer 501. Data communication connections between the peripheral devices and the other components of computer 501 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 523 may include components such as a display screen, speaker, microphone, wearable devices (such as goggles and smart watches), keyboard, mouse, printer, touchpad, game controllers, and haptic devices. Storage 524 is external storage, such as an external hard drive, or insertable storage, such as an SD card. Storage 524 may be persistent and/or volatile. In some embodiments, storage 524 may take the form of a quantum computing storage device for storing data in the form of qubits. In embodiments where computer 501 is required to have a large amount of storage (for example, where computer 501 locally stores and manages a large database) then this storage may be provided by peripheral storage devices designed for storing very large amounts of data, such as a storage area network (SAN) that is shared by multiple, geographically distributed computers. IoT sensor set 525 is made up of sensors that can be used in Internet of Things applications. For example, one sensor may be a thermometer and another sensor may be a motion detector.

Network module 515 is the collection of computer software, hardware, and firmware that allows computer 501 to communicate with other computers through WAN 502. Network module 515 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 515 are performed on the same physical hardware device. In other embodiments (for example, embodiments that utilize software-defined networking (SDN)), the control functions and the forwarding functions of network module 515 are performed on physically separate devices, such that the control functions manage several different network hardware devices. Computer readable program instructions for performing the inventive methods can typically be downloaded to computer 501 from an external computer or external storage device through a network adapter card or network interface included in network module 515.

WAN 502 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 503 is any computer system that is used and controlled by an end user (for example, a customer of an enterprise that operates computer 501), and may take any of the forms discussed above in connection with computer 501. EUD 503 typically receives helpful and useful data from the operations of computer 501. For example, in a hypothetical case where computer 501 is designed to provide a recommendation to an end user, this recommendation would typically be communicated from network module 515 of computer 501 through WAN 502 to EUD 503. In this way, EUD 503 can display, or otherwise present, the recommendation to an end user. In some embodiments, EUD 503 may be a client device, such as thin client, heavy client, mainframe computer, desktop computer and so on.

Remote server 504 is any computer system that serves at least some data and/or functionality to computer 501. Remote server 504 may be controlled and used by the same entity that operates computer 501. Remote server 504 represents the machine(s) that collect and store helpful and useful data for use by other computers, such as computer 501. For example, in a hypothetical case where computer 501 is designed and programmed to provide a recommendation based on historical data, then this historical data may be provided to computer 501 from remote database 530 of remote server 504.

Public cloud 505 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 505 is performed by the computer hardware and/or software of cloud orchestration module 541. The computing resources provided by public cloud 505 are typically implemented by virtual computing environments that run on various computers making up the computers of host physical machine set 542, which is the universe of physical computers in and/or available to public cloud 505. The virtual computing environments (VCEs) typically take the form of virtual machines from virtual machine set 543 and/or containers from container set 544. It is understood that these VCEs may be stored as images and may be transferred among and between the various physical machine hosts, either as images or after instantiation of the VCE. Cloud orchestration module 541 manages the transfer and storage of images, deploys new instantiations of VCEs and manages active instantiations of VCE deployments. Gateway 540 is the collection of computer software, hardware, and firmware that allows public cloud 505 to communicate through WAN 502.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 506 is similar to public cloud 505, except that the computing resources are only available for use by a single enterprise. While private cloud 506 is depicted as being in communication with WAN 502, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 505 and private cloud 506 are both part of a larger hybrid cloud.

As shown in FIG. 5, one or more of the computing devices, e.g., computer 501 or remote server 504, may be specifically configured to implement an automated action recommendation engine 100. The configuring of the computing device may comprise the providing of application specific hardware, firmware, or the like to facilitate the performance of the operations and generation of the outputs described herein with regard to the illustrative embodiments. The configuring of the computing device may also, or alternatively, comprise the providing of software applications stored in one or more storage devices and loaded into memory of a computing device, such as computing device 501 or remote server 504, for causing one or more hardware processors of the computing device to execute the software applications that configure the processors to perform the operations and generate the outputs described herein with regard to the illustrative embodiments. Moreover, any combination of application specific hardware, firmware, software applications executed on hardware, or the like, may be used without departing from the spirit and scope of the illustrative embodiments.

It should be appreciated that once the computing device is configured in one of these ways, the computing device becomes a specialized computing device specifically configured to implement the mechanisms of the illustrative embodiments and is not a general purpose computing device. Moreover, as described hereafter, the implementation of the mechanisms of the illustrative embodiments improves the functionality of the computing device and provides a useful and concrete result that facilitates automated action recommendation generation based on artificial intelligence based evaluation of received electronic communications and performance of automated actions based on predicted recommendations.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, in a computing device, that provides an action recommendation for a received electronic communication, comprising:
training at least one machine learning computer model, at least by executing a machine learning training operation on the at least one machine learning computer model based on electronic communication features extracted from a plurality of historical electronic communications and actions taken by a user in response to each historical electronic communication in the plurality of historical electronic communications, as specified in a training dataset, wherein the at least one machine learning computer model is trained to predict an action classification that specifies a predicted action that the user will take in response to receiving electronic communications;
receiving a new electronic communication via one or more data networks;
extracting electronic communication features of the new electronic communication;
processing, by the trained at least one machine learning computer model, the electronic communication features of the new electronic communication to generate a predicted action classification for the new electronic communication; and
generating an action recommendation output specifying a recommended action to take corresponding to the predicted action classification for the new electronic communication.

2. The computer-implemented method of claim 1, wherein the electronic communication features comprise one or more of an identifier of a sender of the electronic communication, an identification of one or more receivers of the electronic communication, key terms found in one of a title of the electronic communication or body content of the electronic communication, a designation of an electronic communication thread associated with the electronic communication, a timestamp of the electronic communication, or a storage location of the electronic communication.

3. The computer-implemented method of claim 1, further comprising:
determining, based on the predicted action classification for the new electronic communication, whether an automated execution of an action corresponding to the predicted action classification is to be executed; and
in response to determining that an automated execution of the action corresponding to the predicted action classification is to be executed, automatically executing, by the computing device, the action.

4. The computer-implemented method of claim 3, wherein the action is one of forwarding the electronic communication to another user, responding to the electronic communication with a responsive electronic communication having predefined content, deleting the electronic communication, storing the electronic communication in a predefined storage location, adding the electronic communication to a watchlist data structure, or adding the electronic communication to a deferred action list data structure.

5. The computer-implemented method of claim 1, wherein generating the action recommendation output comprises prioritizing the new electronic communication, relative to one or more previously received electronic communications, based on the predicted action classification for the new electronic communication and predicted action classifications associated with the one or more previously received electronic communications.

6. The computer-implemented method of claim 5, wherein generating the action recommendation output comprises outputting a listing of the new electronic communication and the one or more previously received electronic communications, wherein the listing is ordered according to priority of the new electronic communication and the one or more previously received electronic communications.

7. The computer-implemented method of claim 5, wherein the one or more previously received electronic communications are a subset of a set of previously received electronic communications, wherein the subset is selected based on a specified temporal limit.

8. The computer-implemented method of claim 5, wherein prioritizing the new electronic communication comprises:
grouping the new electronic communication with another previously received electronic communication, in the one or more previously received electronic communications, having a same predicted action classification, to generate a predicted action classification group; and
prioritizing the predicted action classification group relative to other predicted action classification groups corresponding to other predicted action classifications, to thereby generate a first priority of the new electronic communication; and
prioritizing the new electronic communication relative to the other previously received electronic communication within the predicted action classification group based on content of the new electronic communication and content of the other previously received electronic communication, to generate a second priority of the new electronic communication.

9. The computer-implemented method of claim 1, further comprising:
receiving a user input in response to the action recommendation output, wherein the user input specifies whether the user agrees with the predicted action classification, disagrees with the predicted action classification, or specifies an alternative predicted action classification;
updating the training dataset with the new electronic communication and the user input; and
retraining the at least one machine learning computer model based on the updated training dataset.

10. The computer-implemented method of claim 1, wherein the new electronic communication is one of an electronic mail communication or an instant message communication.

11. A computer program product comprising a computer readable storage medium having a computer readable program stored therein, wherein the computer readable program, when executed on a computing device, causes the computing device to:
train at least one machine learning computer model, at least by executing a machine learning training operation on the at least one machine learning computer model based on electronic communication features extracted from a plurality of historical electronic communications and actions taken by a user in response to each historical electronic communication in the plurality of historical electronic communications, as specified in a training dataset, wherein the at least one machine learning computer model is trained to predict an action classification that specifies a predicted action that the user will take in response to receiving electronic communications;
receive a new electronic communication via one or more data networks;
extract electronic communication features of the new electronic communication;
process, by the trained at least one machine learning computer model, the electronic communication features of the new electronic communication to generate a predicted action classification for the new electronic communication; and
generate an action recommendation output specifying a recommended action to take corresponding to the predicted action classification for the new electronic communication.

12. The computer program product of claim 11, wherein the electronic communication features comprise one or more of an identifier of a sender of the electronic communication, an identification of one or more receivers of the electronic communication, key terms found in one of a title of the electronic communication or body content of the electronic communication, a designation of an electronic communication thread associated with the electronic communication, a timestamp of the electronic communication, or a storage location of the electronic communication.

13. The computer program product of claim 11, wherein the computer readable program further causes the computing device to:
determine, based on the predicted action classification for the new electronic communication, whether an automated execution of an action corresponding to the predicted action classification is to be executed; and
in response to determining that an automated execution of the action corresponding to the predicted action classification is to be executed, automatically execute, by the computing device, the action.

14. The computer program product of claim 13, wherein the action is one of forwarding the electronic communication to another user, responding to the electronic communication with a responsive electronic communication having predefined content, deleting the electronic communication, storing the electronic communication in a predefined storage location, adding the electronic communication to a watchlist data structure, or adding the electronic communication to a deferred action list data structure.

15. The computer program product of claim 11, wherein generating the action recommendation output comprises prioritizing the new electronic communication, relative to one or more previously received electronic communications, based on the predicted action classification for the new electronic communication and predicted action classifications associated with the one or more previously received electronic communications.

16. The computer program product of claim 15, wherein generating the action recommendation output comprises outputting a listing of the new electronic communication and the one or more previously received electronic communications, wherein the listing is ordered according to priority of the new electronic communication and the one or more previously received electronic communications.

17. The computer program product of claim 15, wherein the one or more previously received electronic communications are a subset of a set of previously received electronic communications, wherein the subset is selected based on a specified temporal limit.

18. The computer program product of claim 15, wherein prioritizing the new electronic communication comprises:
grouping the new electronic communication with another previously received electronic communication, in the one or more previously received electronic communications, having a same predicted action classification, to generate a predicted action classification group; and
prioritizing the predicted action classification group relative to other predicted action classification groups corresponding to other predicted action classifications, to thereby generate a first priority of the new electronic communication; and
prioritizing the new electronic communication relative to the other previously received electronic communication within the predicted action classification group based on content of the new electronic communication and content of the other previously received electronic communication, to generate a second priority of the new electronic communication.

19. The computer program product of claim 11, wherein the computer readable program further causes the computing device to:
receive a user input in response to the action recommendation output, wherein the user input specifies whether the user agrees with the predicted action classification, disagrees with the predicted action classification, or specifies an alternative predicted action classification;
update the training dataset with the new electronic communication and the user input; and
retrain the at least one machine learning computer model based on the updated training dataset.

20. An apparatus comprising:
at least one processor; and
at least one memory coupled to the at least one processor, wherein the at least one memory comprises instructions which, when executed by the at least one processor, cause the at least one processor to:
train at least one machine learning computer model, at least by executing a machine learning training operation on the at least one machine learning computer model based on electronic communication features extracted from a plurality of historical electronic communications and actions taken by a user in response to each historical electronic communication in the plurality of historical electronic communications, as specified in a training dataset, wherein the at least one machine learning computer model is trained to predict an action classification that specifies a predicted action that the user will take in response to receiving electronic communications;
receive a new electronic communication via one or more data networks;
extract electronic communication features of the new electronic communication;
process, by the trained at least one machine learning computer model, the electronic communication features of the new electronic communication to generate a predicted action classification for the new electronic communication; and
generate an action recommendation output specifying a recommended action to take corresponding to the predicted action classification for the new electronic communication.
